(19) United States
(12) Patent Application Publication
(10) Pub. No.: US 2009/0192831 A1
(43) Pub. Date: Jul. 30, 2009

(54) SECURITIZATION OF HEALTH CARE RECEIVABLES

(75) Inventors: Sylvain Rock Raynes, Jackson Heights, NY (US); Ann Elaine Rutledge, Jackson Heights, NY (US); William D. Lanzen, North Kings Town, RI (US)

Correspondence Address: WEINGARTEN, SCHURGIN, GAGNEBIN & LEBOVICI LLP, TEN POST OFFICE SQUARE, BOSTON, MA, 02109, US

(73) Assignee: STANDARD MEDICAL ACCEPTANCE CORPORATION, New York, NY (US)

(21) Appl. No.: 12/359,658

(22) Filed: Jan. 26, 2009

Related U.S. Application Data
(60) Provisional application No. 61/062,396, filed on Jan. 25, 2008.

(51) Int. Cl. G06Q 40/00; G06Q 90/00

(52) U.S. Cl. 705/4; 705/40; 705/35

(57) ABSTRACT

A method, system, and control program for expediting payment of claims to service providers and to reduce institutional capital reserves. The method includes evaluating a risk of full payment of each claim; grouping claims from a service provider(s) based on a commonality of risk; generating a security representative of the risk of the grouped claims and an investment value of the security; and exchanging a pre-payment amount to medical service providers for the security. More specifically, evaluating the risk of full payment includes comparing each individual claim to a database of historical performance of the service provider and of similar claims and, moreover, evaluating for each claim an expected payment amount and an expected time (or delay) of payment by an obligor.

### CROSS REFERENCE TO RELATED APPLICATIONS

This application claims priority under 35 U.S.C. §119(e) to provisional patent application Ser. No. 61/062,396 filed Jan. 25, 2008, the disclosure of which is hereby incorporated by reference.

### STATEMENT REGARDING FEDERALLY SPONSORED RESEARCH OR DEVELOPMENT

N/A

### BACKGROUND OF THE INVENTION

The U.S. health care system is by far the most technologically advanced among the industrialized nations and continues to provide world leadership in areas such as pharmaceuticals and life support technology. If the health care system is currently in crisis, it is not for want of ideas but rather for want of financial discipline.

A central problem in the health care system is the misalignment in financial motivations of the two main players: the insurance companies and the medical establishment. Therefore, one solution to this problem is to realign these two incentives. Medical insurance companies have two main functions: underwriting and claim payments on the one hand, and investment on the other. On the underwriting side, agents and accountants process the corresponding claims paperwork. On the investment side, cash reserves are invested with minimal real knowledge of the inner workings of the insurance industry by the investors. Typically, little or no communication is made between underwriters and investors.

The divide between underwriters and investors is difficult to bridge without a way to funnel excess liquidity from the investment department to finance the receivables in inventory with the claims payment department. Such a funnel can be created in the form of short-term securities created from medical-receivable backed securities. The solution then, is to redistribute some of the excess liquidity at insurance companies to doctors, hospitals, and other medical service providers (collectively “medical service providers”) by bundling the claims originated by the medical service providers into “medical-backed securities” and selling them to the insurance companies liable to pay these very claims. The present invention is directed to a framework for implementing such a solution.

U.S. Pat. No. 7,254,555 to Field (“Field”) purports to disclose a computerized system to allow healthcare providers to “sell” their medical claims as asset-backed commercial paper (ABCP) through conventional ABCP conduits. More specifically, Field generates data on historical collection experience of the healthcare provider's claims. These data include a net collectible value matrix that provides the number of claims actually paid by individual payers, e.g., patients and medical insurance companies, and a time-to-payment histogram. The system further tracks pools of claims using statistical data that includes net collectible value matrix, which includes the number of claims paid and the standard deviation of this percentage; and a collection histogram for payment timing from the billing date of the service.

The Field patent, however, does not provide a vehicle for the securitization of individual and pooled claims nor does the Field system provide real-time re-evaluation of the value of individual claims, e.g., using valuation feedback. Securitization refers to pooling or packaging an expected future cash flow into securities that can be sold to investors for a lump sum payment or timed lump sum payments. Advantageously, especially with lending institutions or other regulated institutions that must maintain a capital reserve, use of ABCP conduits can reduce those reserves.

The Field system also is static in that advance rates of the ABCP are not changed in real-time to reflect the most recent historical data of the individual claims and the medical service provider. Instead, Field relies on third-party rating agencies to estimate value. For example, Field teaches using an 18 to 24 month collection period before updates. In today's fast moving securities industry, when the average life of a medical claim is approximately 45 days, waiting for 18 or 24 months is unacceptable.

Accordingly, it would be desirable to provide a dynamic securitization system for high-volume claims, such as medical service claims, that valuates and re-valuates individual claims in real-time, to update contemporaneously and continuously the bankable value, e.g., the primary advance rate, of the individual claim. It would also be desirable to provide a securitization system that obviates using third-party rating agencies. It would further be desirable to provide a securitization system that enables lending institutions and other regulated institutions to reduce capital reserves and free-up more capital for investment elsewhere.

### SUMMARY OF THE INVENTION

Methods for expediting payment of claims to medical service providers and for reducing bank capital reserve requirements are disclosed. The methods include evaluating a risk of full payment of each medical claim; grouping a plurality of individual claims from a medical service provider(s) based on a commonality of risk; generating a security representative of the risk of the grouped claims and an investment value of the security; and exchanging a pre-payment amount to the medical service provider(s) for the security. More specifically, evaluating the risk of full payment includes comparing individual medical claims to a database of historical performance of the medical service provider(s) and of similar medical claims and, moreover, evaluating the risk of full payment includes evaluating for each individual claim an expected payment amount and an expected time of payment by an obligor(s). The method further includes providing a supplemental payment amount(s) to the medical service provider(s) after payment by the obligor(s).

A claims statistical valuation engine is also disclosed. The valuation engine includes a database(s) containing data on high-volume, e.g., medical, claim histories; means for generating an advance payment value relating to an expected future payment amount and an expected payment time for each individual claim based on said data; means for synthesizing similar or substantially similar advance payment values into plural pools of individual, high-volume claims; and means for generating a claim-backed security having a primary advance rate for sale to an investor.

A system program that is embodied on a computer readable medium and executable on a computer processor is disclosed. The program is adapted to execute the method described above and to control the valuation engine described above.

### BRIEF DESCRIPTION OF THE SEVERAL VIEWS OF THE DRAWING

The invention will be more fully understood by reference to the following detailed description of the invention in conjunction with the drawings, of which:

FIG. 1 illustrates the operation of a monetary performance incentive method according to an embodiment of the present invention; and

FIG. 2 illustrates a flow chart of a health care securitization method according to an embodiment of the present invention.

### DETAILED DESCRIPTION OF THE INVENTION

The present invention introduces a monetary performance incentive for doctors, hospitals, and other medical service providers (collectively “medical service providers”) to deliver medical services at cost effective levels. Although the invention will be described in terms of medical service claims and the medical service industry, the invention is not to be construed as being limited thereto. Specifically, the present invention applies to any industry characterized by a high-volume of individual claims whose promises of future payment or cash flow can be the subject of securitization.

Moreover, although the invention will be described in connection with a bank lending scenarios, the invention is not to be construed as being limited thereto as there are a host of institutional and private lenders to whom the securities offered for sale in accordance with the present invention would interest.

In the traditional operation of the relationship between obligors, e.g., patients, medical insurance companies, Medicare/Medicaid, and the like, and medical service providers, a service provider submits a claim under a patient's insurance policy for reimbursement for the non co-pay or non-deductible portion of the patient's service costs. Processing and acceptance by the obligor could take weeks to months to process and only then does the service provider receive payment from the obligor. When the obligor's payment and the co-pay do not equal the provider's service costs, the provider then must bill the patient for the balance. This time- and labor-intensive process increases provider overhead, and, therefore, service costs, and provides no incentive to file correct claims. Correct claims include, without limitation, those claims that are expressly covered by the patient's insurance carrier in contrast to “incorrect” claims that are expressly not covered.

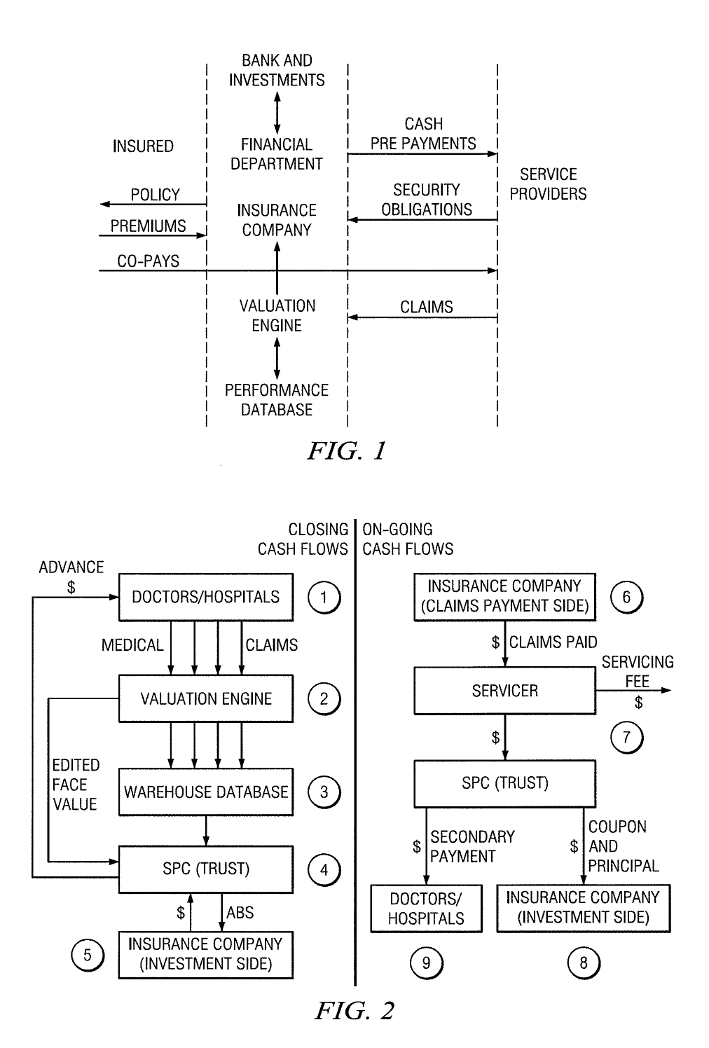

According to the invention and referring to FIG. 1, individual claims coming in from a service provider(s) are pooled into a group(s) for which the risk of full payment can be evaluated based on several factors including past history. The use of the World Wide Web, e.g., the Internet, for forwarding the data related to individual claims from service providers to a valuation engine is expressly envisioned. The valuation engine can be disposed with the obligor, e.g., the patient's medical insurance company, or with a third party, e.g., a claim-processing firm.

Using any of well known algorithms, the valuation engine assesses the investment value of the pooled claims using a database(s) of historical performances of the corresponding providers' claims. With this information the financial department of the insurer (or the third party) produces securities, e.g., asset-backed commercial paper (ABCP), that represent that estimated value. Advantageously, the pooled claims undergo securitization.

The insurer (or third party) exchanges these securities for a lump sum, discounted valued amount, effectively prepaying all or some portion of the claim at a pre-determined and agreed upon discount for which the insurer (or third party) receives the security and its accompanying promise of future payment(s). The terms of the security agreement include, in exchange for prepayment of the claimed amount, certain contractual provisions that are necessary for securitization, chief of which is that the pooled claims are subject to a lien. Thus, the claims serve as collateral for investors.

For example, the insurer (or third party) can file financial statements under a local Uniform Commercial Code, e.g., UCC-1, to record a lien on the securities. Such liens can be filed for the entire nominal amount of the pooled claims, subject to reformation and removal. Only a portion of the nominal claim amount, however, is expected to be reimbursed.

This serves several functions. First, it provides the service provider with more rapid, e.g., immediate, partial payment, before the claims are evaluated by the insurer. The extent of the partial payment—if any at all—is based on historical data on similar individual claims associated with the respective service provider. Secondly, once the insurer completes the claim evaluation, subsequent payment(s) is made to the investor or, in some instances, to a trustee. Subsequent payments may include a surplus or a deficit. Any surplus is distributed and any deficit is assessed among the participants, which include the investors, the service providers, and any third parties. The investment is, then, terminated and the security essentially expires. Individual security liens placed on the claims are subsequently modified or removed once the claims are, respectively, partially or fully adjudicated.

The details of operation of this system are shown in FIG. 1. A description of the applicable theory and mathematics involved, from which an algorithm, application, driver program, and the like can be derived, follows.

A major competitive advantage of the present invention is its ability to create statistically uniform pools of high-volume claims, e.g., medical claims, on a real-time basis. By this, we mean that each pool includes a heterogeneously distributed set of claims from various sellers (or other third parties) and is required to have homogeneous statistical properties if it is going to be eligible for securitization inside a commercial paper conduit or a liquidity-backed exchange (LBE) expecting uniform risk.

Once assembled, the securities or liabilities backed by such pools can be made available to primary market investors, e.g., using a Web-enabled interface, at a discount rate that has been pre-determined, e.g., using an auction process similar to which happens, for example, with student-loan asset-backed securities (ABS).

In credit markets with liquidity support, the goal is always the same, which is to say: to ensure that the liquidity characteristics of the underlying assets are such as to guarantee on a statistical basis that investors will be reimbursed on time and in full with an extremely high probability, which is usually in the neighborhood of 99%. However, to ensure that high probability reimbursement happens at an affordable cost, the distribution of claim payments, both in the dollar and time domains, needs to be computed as accurately as possible, to allow investors to gauge an amount of external liquidity that might eventually be required. External liquidity may be needed in the event that liquidity properties required of commercial paper or liquidity-backed notes are not generally available in the credit markets on a stand-alone basis. In short, statistical certainty, although highly desirable, is not sufficient because capital markets mandate absolute certainty of full and timely payment(s).

As a result of the need for absolute certainty, a large financial institution acting as a sponsor, normally labeled a “liquidity bank”, must be available to stand in for the underlying assets should the CP or ABS fail to live up to their original statistical promise. Notwithstanding, it is most definitely not the intention of the liquidity provider to “stand in” on every possible pool. As a result, liquidity banks will typically require that the claim pools be highly liquid on their own.

To that end, the objective, then, is to assemble pools of high-volume claims, e.g., medical claims, on a first-come, first-serve basis and to issue therefrom the smallest pool possible that simultaneously meets the cash flow requirements imposed by respective liquidity providers.

A “physical claim” consists of a sequence of logical claims, which we label “sub-claims” to ease the interpretation. Each physical claim, although submitted as a whole, may be paid in whole or in part at various stages at the option of the insurance company. This means that individual service items included in a claim may be reimbursed at various times. In many cases and for a variety of reasons, some individual sub-claims may not be reimbursed at all.

Despite the fact that the above, disembodied payment mechanics present an obvious cash-flow reconciliation problem that requires expert software systems, from the statistical stand point it creates an opportunity for a more efficient and streamlined financing system. The following nomenclature will be used in the remainder of this document:

| Parameter | Definition |
|---|---|
| c | As a superscript, indicates a claim level quantity |
| sc | As a superscript, indicates a sub-claim level |
| | quantity |
| P | As a superscript, indicates a pool level quantity. |
| $ | As a subscript, indicates a dollar space quantity |
| t | As a subscript, indicates a time space quantity |
| T | Maturity of CP notes for a given pool |
| N | Number of sub-claims in one physical claim |
| M | Number of claims in one CP pool |
| μ | Used anywhere, refers to a mean value |
| σ | Used anywhere, refers to a standard deviation |
| E[x] | Refers to the mathematical expectation operator |
| | (defined below) |
| r | Periodic CP discount rate (capital market quantity) |
| Σ | The covariance matrix with entries σᵢⱼ (defined |
| | below) |
| x^{T} | Means the transpose of vector or matrix x |
| ρ | The correlation coefficient in a two-dimensional |
| | correlation matrix |
| \|Σ\| | The determinant of matrix Σ |
| exp(x) | The exponential function of argument x |
| Σ⁻¹ | The inverse of arbitrary matrixΣ |
| x̅ | Indicates the mean of a quantity, in this case x |
| ω_{$ ji}^{sc} | Model-derived dollar weight of sub-claim j within |
| | claim i |
| αⱼᵢ^{sc} | Billed dollar amount of sub-claim j within claim i |
| pᵢ^{c} | Nominal dollar amount of claimi |
| P₀ | Nominal dollar amount of an arbitrary pool of |
| | M claims |
| α | Pool-level amount of allowable maturing CP notes |
| | (the dependent variable) |
| δ | Default probability of an arbitrary pool of claims |
| | (rating based) |
| f (x, y) | Two-dimensional Gaussian PDF in time [x] and |
| | dollar [y] space |
| ∥x∥ | The Euclidean norm of quantity, vector or matrix x |
| K | The tolerance for the root-locus procedure (see |
| | below) |
| π | 3.14159 . . . . |
| gᵢ | Primary advance for claim i |
| hⱼ | Primary advance for sub-claim j |
| Cₖ^{P} | Aggregate cash flow to the pool after CP notes |
| | mature |
| qₖᵢ | Secondary, monthly cash flow to claim i at the end |
| | of period k |
| T_{c} | Maximum pool life, and where we have by definition T_{c} > T |
| S_{f}^{P} | Pool-level dollar servicing fee (to SMA) |
| β | Pool calibration factor for computing ρ |
| D_{d} | CP dealer discount in basis points |
| sᵣ | SMA servicing fee rate (ca. 50 bps based on P₀) |

In theory, a mathematical expectation operator, E, for a vector, x, consisting of n elements can be defined as follows:

$$E [ x ] = \frac{1}{n} {\sum }_{i = 1}^{n} {x}_{i} .$$

A covariance matrix, Σ, with entries σᵢⱼ can be defined as follows with respect to the components, xᵢ, of column-vector, x:

σᵢⱼ≡E[(xᵢ− x̅ᵢ)(xⱼ− x̅ⱼ)].

In vector notation, the covariance matrix can also be written, for some column-vector, x, as:

Σ≡E[(x− x̅)(x− x̅)].

Those of ordinary skill in the art can appreciate that these data are two “dimensions”. The first is a “horizontal” dimension along which expectations will be measured for any one data element. The second is a “vertical” dimension that distinguishes different data elements. For this discussion, we will consider two data elements: time to reimbursement (in days) and reimbursement amount (in $US).

The pool issuing the CP note(s) consists of a set of physical, individual claims provided by medical service providers. Each pool can be assembled “on the run”, which is to say, in real-time, as a different aggregate dollar-amount of medical claims. These pools will evidence a wide ranging universe of claim characteristics in terms of amount, expected payment delay, originating hospital, and so forth. The underwriting criteria arising from any single securitized pool will thus form the basis of a payment distribution forecast. This forecast will need to take place once the market reaches critical mass.

The disclosed algorithm is predicated on the existence of a real-time claim valuation model. Without this model, the statistical parameters needed to assemble uniform pools of claims will not be available when needed. Thus, in the following description, we assume that such a model is available at all times.

### Claim Characteristics

A physical claim, consisting either of a physical piece of paper or, alternatively, of an electronic file stored on a hard drive, a computer disk, and the like, can be regarded as a sequence of N items, e.g., services, procedures, laboratory tests, and so forth. Each such item is defined as a sub-claim and is nominally valued, i.e. billed, at αⱼᵢ^{sc}. Collectively, the sub-claims from the physical claim add up to a pre-determined, future dollar amount, pᵢ^{c}. Consequently, the following nominal relationship holds at all times between the sub-claim nominal amounts and the aggregate claim nominal amount:

$${p}_{i}^{c} = {\sum }_{j = 1}^{N} {a}_{ji}^{sc} \qquad EQN . 1$$

Similarly, a pool containing M physical claims can be nominally valued at P₀ with:

$${P}_{0} = {\sum }_{i = 1}^{M} {p}_{i}^{c} \qquad EQN . 2$$

As mentioned above, each claim can be billed and paid in whole or in part, essentially at the whim of the insurance carrier. As a result, sub-claims are typically reimbursed at various points in time and in various dollar amounts, including zero, prescribed by some pre-existing, complex algorithm. These dollar amount are, by definition, unknown at the time the claim is financed. Indeed, the absence of solid, reproducible knowledge on the reimbursement properties of discrete or complex medical claims is one of the problems solved by the present invention.

With a real-time valuation model, there are four statistical parameters with respect to any claim eligible for financing:

μ_{$ ji}^{sc}=The mean reimbursement for sub-claim j of claim i;
σ_{$ ji}^{sc}=The standard deviation of reimbursements for sub-claim j of claim i;
μₜⱼᵢ^{sc}=The mean reimbursement delay for sub-claim j of claim i; and
σₜⱼᵢ^{sc}=The standard deviation of reimbursement delays for sub-claim j of claim i.

In order to synthesize pool-level parameters, it is necessary to aggregate values at the sub-claim level into a claim-level figure that will later be used in computing pool-level quantities. Because sub-claims are originated and paid independently from each other, we may consider them an independent, two-dimensional dataset and may therefore calculate the following four claim-level measures μ_{$i}^{c}, μₜᵢ^{c}, σ_{$i}^{c} and σₜᵢ^{c} the way we normally do in the case of independent random variables, viz.:

$$\begin{matrix}{μ}_{\$ i}^{c} = {\sum }_{j = 1}^{N} {μ}_{\$ ji}^{sc} & EQN . 3 \\ {μ}_{ti}^{c} = [ {\sum }_{j = 1}^{N} {μ}_{tji }^{sc} {μ}_{\$ ji}^{sc} ] / {μ}_{\$ i}^{c} & EQN . 4 \\ {σ}_{\$ i}^{c} = \sqrt{{\sum }_{j = 1}^{N} {( {σ}_{\$ ji}^{sc} )}^{2}} & EQN . 5 \\ {σ}_{t i}^{c} = \sqrt{{\sum }_{j = 1}^{N} {( {ω}_{\$ ji}^{sc} {σ}_{tji}^{sc} )}^{2}} , {ω}_{\$ ji}^{sc} ≡ {μ}_{\$ ji}^{sc} / {μ}_{\$ i}^{c} . & EQN . 6\end{matrix}$$

### Gaussian Density Function (PDF)

Having computed the above four claim-level measures, which are required to assemble uniform pools of medical claims, a two-dimensional probability density function (PDF) to serve as the basis of note issuance must be specified. In order to do so, the computation of the same four statistical parameters at the pool level is of paramount importance. This is because in order to compute the note amount that the conduit sponsors can safely issue out of any given pool, it is necessary to derive a probability density function of payment amounts and delays.

It is assumed that the density function best reflecting empirical reality is Gaussian. Defining x as the dollar-space variable at the pool level and y as the time-space variable at the pool level, the two-dimensional, Gaussian probability density function can be defined as follows. Given that

z≡[x,y]^{T};

m≡E[z]; and

Σ=The two-dimensional (2D) covariance matrix.

We can express the 2D Gaussian PDF in vector notation as follows:

$$f ( z ) = \frac{1}{2 π {\vert \sum \vert}^{1 / 2}} exp \{ - \frac{1}{2} {( z - m )}^{T} {\sum }^{- 1} ( z - m ) \} \qquad EQN . 7$$

In order to compute the parameters of the covariance matrix, Σ, the following four pool-level statistical measures are needed:
μ_{$}^{P}=Mean pool-level reimbursement for an arbitrary pool;
σ_{$}^{P}=Standard deviation of pool-level reimbursements for an arbitrary pool;
μₜ^{P}=Mean pool-level delay for an arbitrary pool; and
σₜ^{P}=Standard deviation of pool-level delays for an arbitrary pool.

To ensure “vertical” independence at the pool-level, the following equations for an average reimbursement amount and standard deviation of such amount apply:

$$\begin{matrix}{μ}_{\$}^{P} = \frac{1}{M} {\sum }_{i = 1}^{M} {μ}_{\$ i}^{c} ; and & EQN . 8 \\ {σ}_{\$}^{P} = \frac{1}{M} \sqrt{{\sum }_{i = 1}^{M} {( {σ}_{\$ i}^{c} )}^{2}} . & EQN . 9\end{matrix}$$

Likewise, in the case of a time delay variable, the mean reimbursement delay for the given pool can be computed using the following standard independent-variable relationships:

$$\begin{matrix}{μ}_{t}^{P} = \frac{1}{M} {\sum }_{i = 1}^{M} {μ}_{t i}^{c} ; and & EQN . 10 \\ {σ}_{t}^{P} = \frac{1}{M} \sqrt{{\sum }_{i = 1}^{M} {( {σ}_{t i}^{c} )}^{2}} . & EQN . 11\end{matrix}$$

Invoking the central limit theorem, the two-dimensional, joint, i.e., payment amount versus payment delay, distribution will be Gaussian. By strict definition, the central limit theorem is inapplicable because it applies only in one dimension. However, since it is valid at least in one dimension, a Gaussian distribution is more likely to approximate the actual distribution than any other known distribution, save the actual one, which remains unknown a priori. Indeed, the Gaussian distribution represents the least committal density function at our disposal to solve our problem.

The assumption of independence between claims does not mean that the pool is free from correlation at the “horizontal” level. Particularly, the particular characteristics of a discrete claim will have an impact on its reimbursement delay. In general, we find that, on a weighed-average basis, relatively “expensive” claims tend to be reimbursed later than less expensive ones. As a result, computation of the coefficient ρ, which correlates reimbursement amount and reimbursement delay, is required.

Recalling the definition of ρ from basic statistics:

$$ρ ≡ \frac{{σ}_{\$ t}^{P}}{{σ}_{\$}^{P} {σ}_{t}^{P}} . \qquad EQN . 12$$

By, further, defining the co-variance between reimbursement amount and reimbursement delay according to the following equation:

σ_{$t}^{P}=E[(X^{P}−μ_{$}^{P})(Y^{P}−μₜ^{P})] EQN. 13,

in which the “synthetic” parameters are defined as:
X^{P} represents the amount reimbursed on each claim in the pool; and
Y^{P} represents the dollar weighted-average time at which this amount is reimbursed.
The adjective “synthetic” is used because the aggregate amount collected by the pool will come in piecemeal—if at all—as time unfolds.

In order to compute the coefficient ρ, the co-variance term σ_{$t}^{P} must be estimated. To obtain an accurate estimate, a model of how the claims in the pool will be reimbursed, i.e. at what value and with what delay, is necessary. In practice, this forces one to introduce an estimator for such amounts. The estimator can also be used as a calibrating function should pool-liquidity experience ever fall short of a stated goal. Accordingly, with respect to claim i

xᵢ^{c}≈μ_{$i}^{c}−βσ_{$i}^{c} EQN. 14, and

yᵢ^{c}≈μₜᵢ^{c}+βσₜᵢ^{c} EQN. 15.

Variables xᵢ^{c} and yᵢ^{c} in EQNS. 14 and 15, respectively, represent the estimated reimbursement amount and the delay on a given claim. Parameter β in each equation is a calibration parameter aimed at reproducing the anticipated covariant experience within securitized pools. Initially, β=0 but is subject to upward, or even downward, adjustments based on the average liquidity performance of actual pools.

In theory, if the actual values of standard deviations σ_{$}^{P} and σₜ^{P} are available, the value of β is inconsequential. Unfortunately, this is rarely the case. However, once payment histories of a sufficient number of pools is available, the correlation coefficient ρ can be re-computed automatically and more accurate empirical values can replace estimated values.

Assuming that all individual claims within a discrete pool are reimbursed at their average value (less some amount based on their estimated dollar variance), and at their average delay (plus some additional delay based on their estimated temporal variance), the sole covariance term σ_{$t}^{P} is calculated as follows:

$${σ}_{\$ t}^{P} = \frac{1}{M} {\sum }_{i = 1}^{M} ( {x}_{ i}^{c} - {μ}_{\$}^{P} ) ( {y}_{i}^{c} - {μ}_{t}^{P} ) , \qquad EQN . 16$$

which produces an estimate for ρ, the last missing variable needed as an input to the Gaussian PDF. As long as the payment behavior of relatively more expensive claims is correct, ρ will be a positive number. Otherwise, in instances where this is not accurate, the above mechanics can automatically adjust the density function, allowing for a larger advance than within an equivalent pool where significant covariant behavior can be expected.

After expanding the vector notation, the functional relationship for a 2D Gaussian PDF, in which x is a mean reimbursement amount and y is a mean reimbursement delay in the pool as a whole, can be expressed using the following equation:

$$f ( x , y ) = \frac{1}{2 π \sqrt{1 - {ρ}^{2}} {σ}_{\$}^{P} {σ}_{t}^{P}} exp \{ \begin{matrix}\begin{matrix}- \frac{1}{2 ( 1 - {ρ}^{2} )} \\ [ {[ \frac{( x - {μ}_{\$}^{P} )}{{σ}_{\$}^{P}} ]}^{2} - 2 ρ\end{matrix} \\ \begin{matrix}\frac{( x - {μ}_{\$}^{P} ) ( y - {μ}_{t}^{P} )}{{σ}_{\$}^{P} {σ}_{t}^{P}} + \\ {[ \frac{( y - {μ}_{t}^{P} )}{{σ}_{t}^{P}} ]}^{2} ]\end{matrix}\end{matrix} \} . \qquad EQN . 17$$

### Root-Locus Algorithm

Advantageously, the advance rate for the packaged claims sold in a pool is determined so that only a very small percentage of reimbursement events—in terms of both dollar and time domains—lie outside the norms established for this purpose. For the system to operate properly, periodic collections, i.e., payments by obligors, at least equal to the face amount of the maturing liquidity or CP notes backed by the pool (plus associated fees) within a delay of ninety days or less, i.e. when the notes are designed to mature, are required. This total amount will be slightly more than the advance rate experienced by conduit sellers.

Designating this situation event as A, the probability, P(A), that event A will occur can be calculated. Hence, use of a note primary-advance rate yields a constant value, which will be near unity for all intents and purposes.

In practice, if ε is the total average cash amount per claim that should be collected by the expected note maturity date, T, and δ is the allowable default rate based on the rating assigned to the notes, operating criterion can be defined in probabilistic terms by the following equation:

P(X>ε,t<T)=1−δ EQN. 18.

In other words, the face-amount of liquidity notes issued so that the probability of a default on maturing liquidity or CP notes (absent liquidity) should be less than some rating-based threshold. Hence, liquidity providers will not be required to advance funds to the exchange in order to avert an impending default except in rare cases, which, statistically speaking, likely would occur, if at all, only δ percent of the time.

In the event that actions to avoid default become necessary of liquidity providers, any funds already advanced by the liquidity provider become a lien on future cash flows, accruing to the legal vehicle backed by the claims. The discount nature of liquidity markets, however, makes it impossible to wait until sufficient cash comes in to refund the notes in full at some discount rate, i.e., the notes are conceived in terms of liquidity risk, not credit risk.

The allowable average issue amount ε is the sum of the advance rate α on the nominal amount P₀ plus fees to others and third parties. Due to discounting, healthcare providers who sell receivables to the pool receive a pro-rated advance payment that is slightly smaller than α. A servicing fee rate sᵣ to others and third parties, who operate the system, is based on the nominal amount of the claims in a given pool, not on the primary advance rate α. For example,

$${S}_{f}^{P} = {s}_{r} \frac{{P}_{0}}{M} . \qquad EQN . 19$$

Hence, the aggregate fee to others and third parties for a given pool would be the amount sᵣ P₀. Hence, on an average basis:

$$ɛ = α \frac{{P}_{0}}{M} + {S}_{f}^{P} \qquad EQN . 20$$

It should be noted that, once the two-dimensional density function of reimbursement amounts and delays is available explicitly, e.g., using empirical data, it becomes easier to calculate the required amount of cash from which the advance rate can be derived.

Indeed, using EQN. 20, a root-locus search algorithm, in which the maturing note advance rate α is computed, can be performed. The maturing advance rate is the advance rate that ensures that operating criteria are met statistically. Remembering that the maximum collectable dollar amount is P₀, and defining

$$λ = \frac{{P}_{0}}{M} ,$$

the iterated function, G(α), is given by the following equation:

$$G ( α ) ≡ {\int }_{ɛ ( α )}^{λ} {\int }_{0}^{T} f ( x , y ) d x d y - 1 + δ \qquad EQN . 21$$

To determine the unknown advance rate, α, a standard numerical method that stops iterating when ∥G(α)∥, i.e., the norm of G(α), falls below a given threshold, i.e. when ∥G(α)∥≦K, is used. The value of K is largely arbitrary, but a value in the neighborhood of 1% of δ is usually acceptable.

Simpson's rule is more than adequate as an integral formula for the solution of the above root-locus problem. In addition, the roots of the appropriate Tchebychev polynomials as the two-dimensional co-location points at which to evaluate the function ƒ(x,y) can be used in lieu of using equally spaced points.

On a statistical basis, a discrete pool's computed average advance rate will approach the quantity μ_{$}^{P}. This is due to the fact that, for a given pool, the average reimbursement on the total number of individual claims increases linearly while σ_{$}^{P}, the variance of reimbursement amounts, increases less rapidly. It follows, then, that, at some point, the aggregate amount of allowable notes will be sufficiently close to the mean reimbursement value as to be practically indistinguishable from such amount. Consequently, pools of sufficient size need to be assembled in real-time so that hospital-sellers can monetize them for an amount sufficiently close to their fair market value, which is generally understood to equal the mean μ_{$i}^{c}. Otherwise, the average advance on a claim may seem too remote from μ_{$i}^{c} to be acceptable to hospitals. The window of acceptability is likely to be in the neighborhood of 5%. Once it is reached, the pool can be “released” and go on to become a primary market instrument, e.g., in the Web-enabled purchase.

### Allocations of Cash Flow Receipts to Claim-Holders

To compute monetary allocations to each investor or claim-holder, an aggregate claim reimbursement amount, m_{$}^{P}, within a given pool must be determined. This parameter is obtained as follows:

$${m}_{\$}^{P} = {\sum }_{i = 1}^{M} {μ}_{\$ i}^{c} . \qquad EQN . 22$$

However, the upshot of these basic considerations is that the following claim-wise, primary advance allocation ƒᵢ must be satisfied:

$${f}_{i} = ( 1 - {D}_{d} ) \frac{α {P}_{0}}{( 1 + r )} \frac{{μ}_{\$ i}^{c}}{{m}_{\$}^{P}} , i ∈ [ 1 , M ] . \qquad EQN . 23$$

From EQN. 23, the entire proceeds of note issuance, less the dealer discount, D_{d}, is allocated to the sellers, i.e., the medical service providers, based on their pro rata contribution to the pool. The term αP₀/(1+r) is, thus, the aggregate price investors or buyers will pay for the securities. For example, at a discount rate of 4.0% APR, a $1000 pool having an estimated future value of $600, is issued, the notes backed by a given pool can be sold to 90-day (¼-year) buyers for a price of approximately $600/(1+0.04/4)=$594.06.
The price amount would then be available for distribution to conduit sellers with respect to this particular pool. Advantageously, lending institutions and other regulated institutions can reduce capital reserves by a similar amount.

Not only will note discount rates change at least daily according to market supply and demand conditions and other factors, but the quality of the claims found inside a $1,000 pool cannot expect to be uniform for any two pools. Thus, in general, each pool will attract its own advance rate at the time it is sold to investors via the conduit or exchange.

### Sub-claim Allocations

Sub-claim allocations can be computed using the following equation:

$${h}_{j} = {f}_{i} \frac{{μ}_{\$ ji}^{sc}}{{μ}_{\$ i}^{c}} , j ∈ [ 1 , N ] . \qquad EQN . 24$$

The above mechanism guarantees that the entire amount, ƒᵢ, will be allocated fairly to each sub-claim holder, e.g., on a pro rata basis.

### Method for Redistributing Receivables

A method for redistributing the receivables of asset-backed, e.g., medical- and/or healthcare-backed, securities can be based on control theory teachings, by which the only way to minimize the variance of an output is to provide a valuation feedback loop from the output. In another embodiment, a valuation feedback loop can be provided from the output, or the investment side of the medical insurance company, to the source of variation, or the claims payment side. By linking the portfolio returns of the insurance companies' investment function to the status of the claims payment function, an incentive is established to restore the payment system to equilibrium and for closing the financial loop. In this way, the bankable value of individual claims can be updated without exposing the lender to secular deterioration.

Generally, insurance companies may choose whether or not to pay their own claims, foregoing collection of investment income and vice versa. By arranging the mechanics of claims-bundling to allow companies to hold any claim liability but its own, alliances within the company can be prevented that may cause the unbalanced distribution of claim payments and receivables between investment and underwriting. As a result, the average return on any insurance company's investments would be subject to the performance of its competitors' claims paying function. Such a so-called “cross-collateralization” effect would ensure that the optimal solution is for all insurance companies to pay all of their claims on time because any attempt to withhold payment may result in reciprocal behavior from competitors.

According to one embodiment of the present invention as illustrated in the flow chart of FIG. 2, claims are generated by medical service providers in the normal course of business in a first step. Participating medical service providers are required to enter their entire volume of individual claims available to a securitization valuation engine, which are adapted to analyze and process these claims, which will be described in more detail below. If less than all of the claims are made available to the securitization engine, “cherry picking” of some claims would bias the payment performance from predicted estimates. Also, the participation of, for example, a medical group scattered across different regions is desirable for providing geographical diversification to “medical diversification” for increasing the stability of the financing method.

In a second step, the generated individual claims are input to a claims statistical valuation engine, which is structured and arranged to generate values that relate to the expected payment amount and time-to-payment for the claims. The claims statistical valuation engine can include a software program based on evolutionary and self-learning techniques such as “Genetic Algorithms” (GA) and “Neural Networks” (NN). Alternatively, any other statistical or evolutionary technique can be used to value the target medical claims without affecting the method described herein or its embodiments.

The claims statistical valuation engine is adapted to improve the predictive power based on the received data. Databases for public and private medical claim histories for a statistically significant proportion of a known population are utilized by the valuation engine to achieve this end. Such existing national databases typically contain all of the information that is collected at the time that the claim is submitted and includes the date of claim submission as well as the date and amount of claim payment.

Prior to the start of the financing program, the national database is used to establish expected payment dates for any claim submitted by a unique medical service provider based on a vector of predictive parameters such as medical specialty, geography, patient age, condition, and other associated factors. To a large extent, the discovery of the statistical laws enabling prediction has been automated over the years and the production of payment rules via GA and NN has become a fairly routine task. As a result of this valuation step, each type of claim is associated with an expected payment amount as a percentage of its face amount and an expected payment window.

Along with these expected values, the GA and NN can derive standard deviations for the same quantities. These empirical means and standard deviations are used to advance a certain portion of the individual claim's face value to the medical service provider whose claims are included in the pool. The financial arbitration task is, in fact, the valuation engine's main function when used during real-time operations.

Prior to closing, the GA/NN processing performs codification of the parameters of synthetic pools of medical claims with given statistical payment characteristics based on the actual payment history of the large amount of claims available from the commercial databases. This synthesis creates pools of values combining a confidence interval for a cumulative payment percentage in conjunction with an associated cumulative payment window for each individual claim, to provide stability for the method. After being valued by the claims statistical valuation engine, in a third step, each individual claim is stored in a valuation database system and each claim is assigned a unique identifier and its date of submission.

The resulting claims-related characteristics of the synthetic pools are input to a Special Purpose Company's (SPC) operations in a fourth step, which directs the issuance of asset-backed, e.g., medical claims-backed, securities (ABS). After a statistically sufficient number of claims has been accumulated in a timely manner for the creation of a synthetic pool, the parameters are then dictated by a statistical payment behavior.

The SPC then issues fixed or floating income securities backed by the claims and forms an updated synthetic pool because the expected payment history of the synthetic pools is the main component in their formation. These ABS are then available for sale or purchase. Sale to other health insurance companies is desirable.

Generally, an investment in these securities has a relatively short average life because of the relatively short, expected payment window associated with typical medical claims. Nevertheless, it is common to turn a short-term security into a long-term security via a “revolving” period in capital markets operations. However, short term paper may be issued inside special vehicles or “commercial paper conduits.” Many such commercial paper conduits already exist that contain various types of assets, including medical receivables. The method of the present embodiment is independent of the expected maturity of the medical ABS that it will originate, or of the type of vehicle that will originate them.

In a fifth step, the ABS issued by the special purpose vehicles are purchased in a closing cash flow section. For instance, medical insurance companies that are obligors under the claims backing them may purchase these ABS. Proceeds of these sales flow back to the originating medical service providers as primary cash “advances.”

In the present method, the primary advance rate, which is computed as a percentage of the claim's face value, is automatically adjusted to a level commensurate with the performance of the individual medical service provider. As a result, highly efficient providers are advantaged while inefficient organizations are penalized in this method.

The automatic adjustment mechanism is accomplished via at least daily database updates from the actual claims payment experience. At predetermined set times, such as each evening for instance, the valuation engine, or GA/NN algorithm, according to the present method is “re-trained” using the most recent payment data so that advance rates are generated in line with the payment experience.

Efficient organizations tend to have payment experiences closer to the face value of the claims in comparison to inefficient organizations. Accordingly, more efficient organizations are rewarded through higher primary advances and are able to provide a monetary value for a larger portion of their total claim volume up front as compared to less efficient ones.

In a sixth step, after the origination of the claim, the insurance company or other paying entity, such as the U.S. government in the case of Medicare claims, pays the claim. Typically, the payment window falls somewhere between 45 and 180 days. The present method is structured to financially motivate the claims payment function of the obligor so that cash at the investment end is collected in the form of coupon or principal.

Ancillary support functions are used for clearing through the banking system payments made on these claims. Upon payment of the claims, a database manager is notified as to the payment amount remitted and date thereof so that the applicable database can be updated. Preferably, the database manager is notified electronically and the database is automatically updated at that time so that proper credit can be given to the originating medical service provider in real-time.

Simultaneously, the “training set” driving the valuation engine is updated and a copy of the claim's life-cycle history (from filing to payment) is archived for research purposes and the “live” claim is deemed liquidated.

Next, in a seventh step, a fee senior in priority to any or all of the other liens to which the receivable is subjected is collected by the servicing organization (third party) each time that a claim is paid. The servicing organization may consist of a clearing bank, a database manager, a financing vehicle's sponsor and an administrator. This ensures that the integrity of the entire system is predicated on the efficient operation of the servicing infrastructure.

The servicing organization fees are small compared to expected receipts and are usually calculated based on the face amount of the receivable. Although the fees are computed at the time that the claim is paid, the fees are disbursed at predetermined times, such as once a month when other trust expenses are disbursed. Once servicing fees are paid, any remaining amounts are available to security and other stakeholders in the trust.

In an eighth step, the present method performs a feedback loop inside of the insurance companies for effectively re-distributing excess liquidity to medical service providers requiring the same. This re-distribution involves a hierarchy of payments that normally begins with bond interest and principal. Providers that collect residual “equity” income from the receivables fall at the bottom of the hierarchy if the collection account has not been completely depleted at such time. These amounts are collectively referred to as a “secondary payment”, which will be discussed in more detail in the next step.

Under this framework, there may be a tendency for insurance companies to forego investment income stemming from their ABS holdings to avoid payment under their claims-related liability. Potentially, a “late payment syndrome” may still occur as a result of cooperation within the insurance company. Even though such cooperation may provide benefits from the creation of such a dialogue within the company, a better solution to the late payment syndrome problem is to bundle the claims flowing to the financing vehicle in such a way that an insurance company would be allowed only to buy securities backed by competitors' liabilities.

This bundling solution may be implemented by modifying the database management mechanics. For instance, the database may be managed to provide capital relief to cooperating insurance companies to encourage this management and create the necessary financial motivation for optimal cash management on their part.

In a next step, the calculation of secondary payments to medical service providers arising from excess cash flows according to the present embodiment further increases health care management efficiency. Two basic calculation methods of the secondary payments can be performed. The first method partitions any remaining cash flow pro rata among all of the participating providers. Therefore, on each distribution date, a hospital that has contributed 10%, for example, of the face value of all claims that have been liquidated during the previous collection period will be allocated 10% of all remaining cash in the collection account. This method may be referred to as a “socialist” calculation method for being based on a ratably equal sharing of the loss or gain associated with the receivable performance among participating providers.

In a second calculation method, cash is allocated individually according to whether or not the receivable was liquidated above or below its carrying cost. For example, if a $50 advance payment is made initially on a $100 (face amount) receivable and the receivable was liquidated for $40, no secondary payment is made to the originating provider. In fact, the trust would have suffered a $10 loss on that particular receivable. In contrast, if the receivable were liquidated for an amount above the sum of the original advance aggregate servicing fees and interest at the trust's average cost of funds during the time the claim was outstanding, say $60, then the secondary advance would equal the difference between the liquidated proceeds and that sum ($10).

The advantage of the second calculation method is that efficient organizations are not asked to subsidize inefficient ones as in the allocation of the first method. More specifically, less efficient providers may initially be given the benefit of the doubt via receiving expected advance rates on their claims in the first allocation method.

Failure to collect this average amount, however, would result in erasing any secondary advance. In addition, the next claim submitted by the same hospital would be valued at less than the national rate as a consequence of the mechanics of the valuation engine according to the present invention. This process would repeat until the supply of money from collection equals the demand from claim submission. Depending on the provider's internal cost structure, this may increase the chances for bankruptcy. Exactly the reverse phenomenon would apply to efficient providers and with correspondingly opposite results. Therefore, the normal operation of the financing vehicle for the embodiments of the present invention would automatically reward efficient providers, punish inefficient ones, protect ABS investors, and converge towards global systematic optimality at the same time.

### Note Maturity

If the ABS note matures, sufficient aggregate collections are on hand at time T to refund maturing in full. In general, this can be accomplished by aggregating proceeds from all claims acting as security for the notes and allocating them to the liabilities. However, the random reimbursement process taking place is likely to disadvantage providers whose payment record is better than those that tend to collect later, since the funds of the former will be used primarily to reimburse maturing notes.

For this reason, a trust may be kept alive as long as claims can be deemed outstanding and non-defaulted, which is likely to last slightly longer than the maximum allowable note maturity, or approximately one year. Therefore, amounts collected after the note expected maturity date T but before the trust's legal final maturity date T_{c} can be allocated on a monthly basis to medical service providers in a pro rata manner dictated by EQN. 23. The difference, however, is that, instead of the term (1−D_{d})αP₀(1+r)⁻¹, the proper multiplier is Cₖ^{P}, corresponding to the aggregate pool cash flow received during period k. Consequently, during secondary or later collection periods, the holder of claim i is entitled to receive a secondary allocation, qₖᵢ, in accordance with the following formula:

$${q}_{ki} = {C}_{k}^{P} \frac{{μ}_{\$ i}^{c}}{{m}_{\$}^{P}} , i ∈ [ 1 , M ] , k ∈ [ 1 , ( {T}_{c} - T ) ] . \qquad EQN . 25$$

Neither the trustee nor the liquidity bank will have rights to these funds although the Trustee MAY still benefit from float on the amounts, Cₖ^{P}, pending monthly disbursement. Thus, all medical service providers benefit equally from all pool collections.

### Claims Failing to Mature by T_{c}

When claims fail to mature before a pool reaches its legal final maturity date, i.e., within the timeframe, T_{c}, such claims are valued at zero, e.g., using the valuation algorithm, and are included in the database in a next valuation feedback-loop update. Legally, since the trust still has a security interest in the claims, e.g., via the original UCC-1 financing statements filed with the local Secretary of State at the time of the primary advance, at time T_{c} the lien that was placed on all such claims must be released, to enable the medical service provider to collect whatever proceeds they can, without having to funnel the cash flow through the now-defunct trust.

Recalling that the medical service provider received a bona fide, primary advance on this matured claim, and may have received a string of secondary advances thereon while contributing nothing towards the reimbursement of these apparently windfall cash flows, the medical service provider will be penalized in the long term. More specifically, since the matured claim for the particular medical service provider is awarded a zero-valuation, for future claims, the primary advance will be reduced to zero as well, drastically affecting the medical service providers access to cash up-front.

Medical service providers who sell claims to a pool are assumed to be acting in good faith in their attempts to collect their claims. If this is true, it is fair to release the liens on such claims and to penalize the medical service providers by assigning a zero value to the target claims. A rational service provider would want to correct the situation and improve future collection efficiency since the proceeds of claims so sold cannot be diverted without committing fraud.

### Liquidity Stand-in

To avoid default, the liquidity bank may be required to advance funds to avoid an impending default on maturing notes. When this occurs, even if the liquidity provider refunds the notes on their maturity date, T, the claim collection process continues unabated. The liquidity bank effectively becomes the only remaining fixed income creditor since the original investors have already been satisfied via the refund.

When this occurs, the liquidity bank effectively becomes a lender to the conduit, assuming, thereby, a senior position with respect to service providers. Back-stop liquidity contributions now acquire the characteristics of a loan to the service providers and are reimbursable at a prevailing or pre-determined loan rate prior to any secondary allocations to claim holders. In short, in instances in which a liquidity provider makes a loan to a particular pool, the aggregate amount(s), Cₖ^{P}, that become available from obligors for periodic distribution are instead allocated to the liquidity bank as partial repayment of this loan until such time as its terms are satisfied or are not satisfied and the loan is written off by the liquidity bank.

In the unlikely event that, the entire aggregate proceeds, i.e., cash flow, of all monthly periods from T until T_{c} are insufficient to repay the loan, the liquidity bank suffers a loss of principal and/or interest.

It will be apparent to those skilled in the art that other modifications to and variations of the above-described techniques are possible without departing from the inventive concepts disclosed herein. Accordingly, the invention should be viewed as limited solely by the scope and spirit of the appended claims.

1. A method for expediting payment of high-volume individual claims to service providers, the method comprising:
evaluating a risk of full payment of each individual claim;
grouping a plurality of claims from at least one medical service provider based on one or more common factors bearing on a risk;
generating a security representative of the risk of the grouped claims and an investment value of the security; and
exchanging a pre-payment amount to the at least one medical service provider for said security.

2. The method as recited in claim 1, wherein evaluating the risk of full payment includes comparing each individual claim to a database of historical performance of the at least one service provider and of similar claims.

3. The method as recited in claim 1, wherein evaluating the risk of full payment includes computing for each claim an expected payment amount and an expected time of payment by an obligor.

4. The method as recited in claim 3 wherein valuating includes determining or estimating a standard deviation of the expected payment amount and a standard deviation of the expected time of payment.

5. The method as recited in claim 3 further comprising providing a supplemental payment amount to the at least one medical service provider after payment by the obligor.

6. The method as recited in claim 5, wherein the supplemental payment amount is calculated as some portion of a mathematical difference between the payment by the obligor and the pre-payment amount.

7. The method as recited in claim 1 further comprising perfecting and recording a security interest on individual claims within the grouped claims.

8. The method as recited in claim 7, wherein perfecting and recording the security interest includes at least one of modifying, reforming, and removing said security interest after the grouped claims are at least partially adjudicated.

9. The method as recited in claim 1, wherein said security includes provisions that the at least one medical service provider agrees to in exchange for the pre-payment amount.

10. The method as recited in claim 1 further comprising creating reports of characteristic performance measures of the grouped claims.

11. A claims statistical valuation engine, the valuation engine comprising:
at least one database containing data on claim histories and on payment histories of corresponding service providers;
means for generating an advance payment value relating to an expected payment amount and an expected payment time for each individual claim based on said data;
means for synthesizing similar or substantially similar advance payment values into plural pools of claims; and
means for generating a claim-backed security having a primary advance rate for sale to an investor.

12. The valuation engine as recited in claim 11, wherein the data on claim histories include predictive parameters that are selected from the group consisting of medical specialty, regional geography, age of patient, and condition of patient.

13. The valuation engine as recited in claim 11 further comprising means for adjusting the primary advance rate in real-time, to account for performance of the service providers.

14. The valuation engine as recited in claim 11 further comprising means for determining when and an amount of payment for a claim upon remittance by an obligor.

15. The valuation engine as recited in claim 14 further comprising means for updating the at least one database to include said remittance.

16. The valuation engine as recited in claim 14 further comprising means for generating a supplemental payment value to one or more claimants based on the remittance.

17. The valuation engine as recited in claim 14 further comprising means for determining a standard deviation of when and a standard deviation of the amount of payment for the claim.

18. The valuation engine as recited in claim 11 further comprising means for perfecting and recording a security interest on at least one individual claim within any of the plural pools.

19. A computer program product in the form of a computer readable media having a computer program stored thereon, the computer program being executable on a processor and comprising executable machine language or code for:
evaluating a risk of full payment of at least one individual claim;
grouping a plurality of claims from at least one service provider based on one or more common factors bearing on a risk;
generating a security representative of the risk of the grouped claims and an investment value of the security; and
exchanging a pre-payment amount to the at least one service provider for said security.

20. The program as recited in claim 19, wherein evaluating the risk of full payment includes comparing each claim to a database of historical performance of the at least one service provider and of similar medical claims.

21. The program as recited in claim 19, wherein evaluating the risk of full payment includes evaluating for each claim an expected payment amount and an expected time of payment by the obligor.

22. The program as recited in claim 19, wherein evaluating the risk of full payment includes evaluating for each claim a standard deviation for the expected payment amount and a standard deviation for the expected time of payment.

23. The program as recited in claim 19 further comprising perfecting and recording a security interest on individual claims within grouped claims.

24. The program as recited in claim 23, wherein perfecting and recording the security interest includes at least one of modifying, reforming, and removing said security interest after the grouped claims are at least partially adjudicated.

25. A method for reducing capital reserves maintained by an institution by expediting payment of high-volume individual claims to service providers, the method comprising:
evaluating a risk of full payment of each individual claim;
grouping a plurality of claims from at least one medical service provider based on one or more common factors bearing on a risk;
generating a security representative of the risk of the grouped claims and an investment value of the security;
exchanging a pre-payment amount to the at least one medical service provider for said security; and
reducing the capital reserves of the corresponding institution by an amount equal to a portion of the pre-payment amount required by bank capital regulations.

26. The method as recited in claim 25 further comprising perfecting and recording a security interest on individual claims in grouped claims.

27. The method as recited in claim 26, wherein perfecting and recording the security interest includes at least one of modifying, reforming, and removing said security interest after the grouped claims are at least partially adjudicated.
